(19) United States
(12) Patent Application Publication
(10) Pub. No.: US 2025/0174131 A1
(43) Pub. Date: May 29, 2025

(54) SYSTEMS AND METHODS FOR PROVIDING NOTIFICATIONS TO PILOTS OF AIRCRAFT

(71) Applicant: THE BOEING COMPANY, Arlington, VA (US)

(72) Inventors: Jeffrey Lee Williams, Littleton, CO (US); Michael R. Grier, Aurora, CO (US); Aaron Pilcher, Englewood, CO (US)

(73) Assignee: THE BOEING COMPANY, Arlington, VA (US)

(21) Appl. No.: 18/519,174

(22) Filed: Nov. 27, 2023

(51) Int. Cl. G08G 5/00

(52) U.S. Cl. CPC G08G 5/21; G08G 5/50; G08G 5/55; G08G 5/70

(57) ABSTRACT

A system and a method include an artificial intelligence control unit configured to receive data from notification sources. The data relate to an aircraft being operated by a pilot. The artificial intelligence control unit is further configured to determine relevant information for operating the aircraft from the data, and provide an information presentation including the relevant information on a display of a user interface of the aircraft. The aircraft is operated based on the relevant information.

### FIELD OF THE DISCLOSURE

Examples of the present disclosure generally relate to systems and methods for providing notifications to pilots of aircraft.

### BACKGROUND OF THE DISCLOSURE

Aircraft are used to transport passengers and cargo between various locations. Numerous aircraft depart from and arrive at a typical airport every day.

Pilots typically receive information from numerous data sources before and during a flight. For example, pilots receive Notice to Air Missions (NOTAMs), airport notes, current weather conditions, airline-specific briefing content, and/or the like. As such, pilots sift through the information to determine what is uniquely relevant to a particular flight. However, the copious amount of information may prove difficult or impossible to fully analyze.

Hundreds of NOTAMs in briefing packages, hundreds of notes for a set of airport pages, large documents for an airline, and numerous sources of real-time airport weather data may make it difficult for a pilot to determine relevant information for a specific aircraft departing from or arriving at a specific airport and runway on a specific day. Typically, a pilot needs to proactively seek, discover, and synthesize important, relevant information from huge volumes of data.

### SUMMARY OF THE DISCLOSURE

A need exists for a system and a method for automatically determining relevant information regarding operation of an aircraft. Further, a need exists for a system and a method for presenting the relevant information to a pilot of the aircraft.

With those needs in mind, certain examples of the present disclosure provide a system including an artificial intelligence control unit configured to receive data from notification sources. The data relate to an aircraft being operated by a pilot. The artificial intelligence control unit is further configured to determine relevant information for operating the aircraft from the data, and provide an information presentation including the relevant information on a display of a user interface of the aircraft. The aircraft is operated based on the relevant information.

The artificial intelligence control unit can be remote from the aircraft. As another example, the artificial intelligence control unit can be onboard the aircraft.

In at least one example, the notification sources include a tracking sub-system configured to track the aircraft, a weather sub-system, aviation data sources that provide information regarding aviation flight operations, aircraft data sources that provide information about the aircraft, and/or airport data sources that provide information regarding one or more airports.

In at least one example, the information presentation includes a map of a current location of the aircraft. The information presentation can include information prompts that show the relevant information on the display. The information prompts can include one or more feedback input indicators that allow the pilot to provide feedback to the artificial intelligence control unit.

The artificial intelligence control unit can be further configured to automatically operate the aircraft based on the relevant information.

Certain examples of the present disclosure provide a method including receiving, by an artificial intelligence control unit, data from notification sources, wherein the data relate to an aircraft being operated by a pilot; determining, by the artificial intelligence control unit, relevant information for operating the aircraft from the data; and providing, by the artificial intelligence control unit, an information presentation including the relevant information on a display of a user interface of the aircraft. The aircraft is operated based on the relevant information.

Certain examples of the present disclosure provide a non-transitory computer-readable storage medium comprising executable instructions that, in response to execution, cause one or more control units comprising a processor, to perform operations comprising receiving data from notification sources, wherein the data relate to an aircraft being operated by a pilot; determining relevant information for operating the aircraft from the data; and providing an information presentation including the relevant information on a display of a user interface of the aircraft. The aircraft is operated based on the relevant information.

### BRIEF DESCRIPTION OF THE DRAWINGS

FIG. 1 illustrates a block diagram of a system, according to an example of the present disclosure.

FIG. 2 illustrates a flow diagram of a method, according to an example of the present disclosure.

FIG. 3 illustrates a front view of a display, according to an example of the present disclosure.

FIG. 4 illustrates a schematic block diagram of a control unit, according to an example of the present disclosure.

FIG. 5 illustrates a perspective front view of an aircraft, according to an example of the present disclosure.

### DETAILED DESCRIPTION OF THE DISCLOSURE

The foregoing summary, as well as the following detailed description of certain examples will be better understood when read in conjunction with the appended drawings. As used herein, an element or step recited in the singular and preceded by the word “a” or “an” should be understood as not necessarily excluding the plural of the elements or steps. Further, references to “one example” are not intended to be interpreted as excluding the existence of additional examples that also incorporate the recited features. Moreover, unless explicitly stated to the contrary, examples “comprising” or “having” an element or a plurality of elements having a particular condition can include additional elements not having that condition.

Examples of the present disclosure provide an intelligent, contextual, summarized digest of relevant airport and runway information for pilots relative to their operation, fleet, runway configuration, and current environmental conditions using trajectory-related pattern recognition algorithms and natural language processing of dynamic data (for example, NOTAMs, weather data, and the like), spatial data, static airport data (for example, airport charted notes, fleet specific restriction data), airline-specific data, and crowd-sourced usage patterns.

In at least one example, an artificial intelligence control unit uses machine learning and natural language processing to reduce a total quantity of unnecessary information presented to a pilot, and provide relevant data into a single, simple view that can be used in conjunction with dynamic airport maps. In contrast to known methods, examples of the present disclosure provide a strategic, push-oriented process, which elevates important information to a pilot.

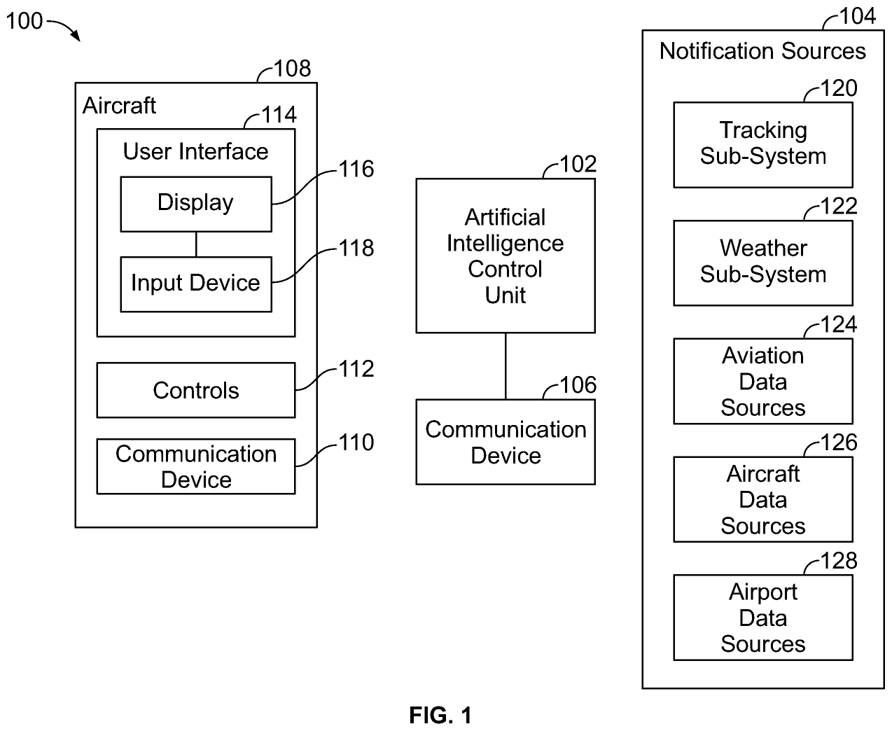

FIG. 1 illustrates a block diagram of a system 100, according to an example of the present disclosure. The system 100 includes an artificial intelligence control unit 102 in communication with a plurality of notification sources 104, such as through one or more wired or wireless connections. For example, the artificial intelligence control unit 102 can be coupled to a communication device 106 that receives data from the notification sources 104. The communication device 106 can be one or more of an antenna, a transceiver, an internet connection, a cloud-based connection, and/or the like.

The artificial intelligence control unit 102 is also in communication with an aircraft 108, such as via communication between the communication device 106 and a communication device 110 of the aircraft 108. The communication device 110 can also be an antenna, a transceiver, an internet connection, a cloud-based connection, and/or the like. In at least one example, artificial intelligence control unit 102 is separate and distinct from the aircraft 108. For example, the artificial intelligence control unit 102 can be located at a central monitoring location, which can be remote from, or optionally co-located with, one or more of the notification sources 104. As another example, the artificial intelligence control unit 102 can be onboard the aircraft 108, such as within a flight deck or cockpit. For example, the artificial intelligence control unit 102 can be part of a flight computer of the aircraft 108.

The aircraft 108 includes controls 112 configured to allow an operator, such as a pilot, to control operation of the aircraft 108. For example, the controls 112 include one or more of a control handle, yoke, joystick, control surface controls, accelerators, decelerators, and/or the like.

The aircraft 108 also includes a user interface 114, such as within a flight deck or cockpit of the aircraft 108. The user interface 114 includes a display 116 and an input device 118. The display 116 can be a monitor, screen, television, touchscreen, and/or the like. The input device 118 can include a keyboard, mouse, stylus, touchscreen interface (that is, the input device 118 can be integral with the display 116), and/or the like. The user interface 114 can be, or part of, a computer workstation. For example, the user interface 114 can be part of the flight computer within the flight deck or cockpit of the aircraft 108. As another example, the user interface 114 can be a handheld device, such as a smart phone, tablet, or the like.

In operation, the artificial intelligence control unit 102 receives data from the notification sources 104. The data includes vast amounts of information from numerous different notification sources 104. The notification sources 104 include a tracking sub-system 120, which is configured to track the aircraft 108. In at least one example, the tracking sub-system 120 is configured to track positions of the aircraft 108 in real time. In at least one example, the tracking sub-system 120 is a radar sub-system. As another example, the tracking sub-system is an automatic dependent surveillance-broadcast (ADS-B) tracking sub-system. Real time positions of the aircraft 108 on the ground and within an airspace are detected by the tracking sub-system 120 that receives position signals output by a position sensor of the aircraft 108. For example, the tracking sub-system 120 receives ADS-B signals output by the position sensors of the aircraft 108. As another example, the position sensor of the aircraft 108 can be global positioning system sensors. The position sensor outputs signals indicative of one or more of the position, altitude, heading, acceleration, velocity, and/or the like of the aircraft 108. The signals are received by the tracking sub-system 120.

The notification sources 104 also include a weather sub-system 122, which provides past, current, and predicted weather for locations of the aircraft 108, airports, and the like. As an example, the weather sub-system 122 can include a weather station, channel, or the like. As another example, the weather sub-system 122 can include aeronautical weather services that provide weather notifications at various locations, such as airports.

The notification sources 104 also include aviation data sources 124, which provide information regarding aviation flight operations. Examples of the aviation data sources 124 includes NOTAMs, aircraft communication addressing and reporting system (ACARS), Digital Automatic Terminal Information Service (D-ATIS), and the like.

The notification sources 104 also include aircraft data sources 126, which provide information about various aircraft. For example, the aircraft data sources 126 include information regarding a type and capabilities of the aircraft 108. The aircraft data sources 126 can be information provided by a manufacturer, maintenance provider, operator, and/or the like of the aircraft 108.

The notification sources 104 also include airport data sources 128, which provide information regarding an airport, such as a departure airport and/or an arrival airport for the aircraft 108. The airport data sources 128 can include airport map data, including locations of runways, taxiways, gates, and the like.

In operation, the artificial intelligence control unit 102 receives the data from the notification sources 104. The data includes information related to a past, current, and/or future flight of the aircraft 108. For example, the data includes position and trajectory information for the aircraft 108, such as provided by the tracking sub-system 120, weather information at a location of the aircraft 108, a departure airport, and an arrival airport, such as provided by the weather sub-system 122, information regarding aviation flight operations, such as provided by the aviation data sources 124, information regarding the aircraft, such as provided by the aircraft data sources 126, and information regarding airports, such as provided by the airport data sources 128.

The artificial intelligence control unit 102 receives all of the data from the notification sources 104, and performs pattern recognition to automatically determine (without human intervention) relevancy of the information. For example, based on learned patterns from past flights, the artificial intelligence control unit 102 provides a relevancy score for the various data received from the notification sources. The artificial intelligence control unit 102 ignores information that is below a predetermined relevancy threshold (such as determined through pattern recognition). If the information meets or exceeds the predetermined relevancy threshold, the artificial intelligence control unit 102 outputs the information to the user interface 114. For example, the artificial intelligence control unit 102 shows the relevant information on the display 116. In at least one example, the artificial intelligence control unit 102 uses an aviation-based large language model to determine the relevant information and provide the relevant information to a pilot on the display 116. In at least one example, the artificial intelligence control unit 102 generates an information presentation, which can include a map of a current location of the aircraft 108. The information presentation also includes information prompts, which show the relevant information on the display 116.

In at least one example, the information prompts can further include feedback input indicators. The pilot can select the feedback input indicators to provide feedback to the artificial intelligence control unit 102. For example, if the information prompt is helpful to the pilot, the pilot can provide approval via the feedback input indicator. Conversely, if the information prompt is not helpful, the pilot can provide a rejection via the feedback input indicator. The artificial intelligence control unit 102 can use such feedback to further refine the large language model in order to further refine selection of relevant information in the future.

The aircraft 108 is operated, such as on the ground at an airport or in the air, based on the relevant information, as determined by the artificial intelligence control unit 102. For example, a pilot views the relevant information, which is automatically determined by the artificial intelligence control unit 102 and shown on the display 116 via the information presentation, and operates the aircraft 108 according to the relevant information.

In at least one example, the artificial intelligence control unit 102 can also be in communication with the controls 112 of the aircraft 108, and configured to automatically operate the controls 112, based on the determined relevant information. As an example, the artificial intelligence control unit 102 can automatically operate the aircraft 108 in a holding pattern based on determined relevant information, such as a predicted holding time for the aircraft 108 at an arrival airport. Optionally, the artificial intelligence control unit 102 may not be in communication with the controls 112, and may not be configured to automatically operate the aircraft 108.

As described, the artificial intelligence control unit 102 receives data from the notification sources 104, such as flight operations data, aircraft trajectory, pilot inputs, aeronautical/geospatial databases, and the like. The artificial intelligence control unit 102 applies the aviation-based large language model in relation to the data to determine the relevant information and generate prompts, which are shown on the display 116 for a pilot to view and consider. In at least one example, the artificial intelligence control unit 102 recognizes patterns in the data, and based on such patterns, learns which aeronautical conditions and events indicate a need for pilots to access certain information, and thereby uses such to suggest appropriate prompts for notification.

In at least one example, the large language model is aviation specific, and is configured to extract relationships, and parse semantics. In at least one example, the artificial intelligence control unit 102 is configured to provide machine learning pattern recognition in supervised algorithms that performs classifications, regressions, and decision-tree operations specific to the inputs from aeronautical datasets and usage analytics. The artificial intelligence control unit 102 can also receive crowd-sourced feedback looping from actual usage data to assist in training the pattern recognition, and further refining the large language model.

As described herein, the artificial intelligence control unit 102 is configured to provide an intelligent, contextual, summarized digest of relevant airport and runway information for pilots relative to their operation, fleet, runway configuration, and current environmental conditions using trajectory-related pattern recognition algorithms and natural language processing of dynamic data (for example, NOTAMs, weather data, and the like), spatial data, static airport data (for example, airport charted notes, fleet specific restriction data), airline-specific data, and crowd-sourced usage patterns. In at least one example, the artificial intelligence control unit 102 uses machine learning and natural language processing to reduce a total quantity of unnecessary information presented to a pilot, and provide relevant data into a single, simple view (that is, the information presentation on the display 116) that can be used in conjunction with dynamic airport maps. In contrast to known methods, examples of the present disclosure provide a strategic, push-oriented process, which highlights important information for a pilot.

As described herein, the system 100 includes the artificial intelligence control unit 102, which receives data from the plurality of notification sources 104. The data relate to the aircraft 108 being operated by a pilot. The artificial intelligence control unit 102 further determines relevant information for operating the aircraft 108 from the data. The artificial intelligence control unit 102 provides an information presentation including the relevant information on the display 116 of the user interface 114 of the aircraft 108. The aircraft 108 is operated based on the relevant information.

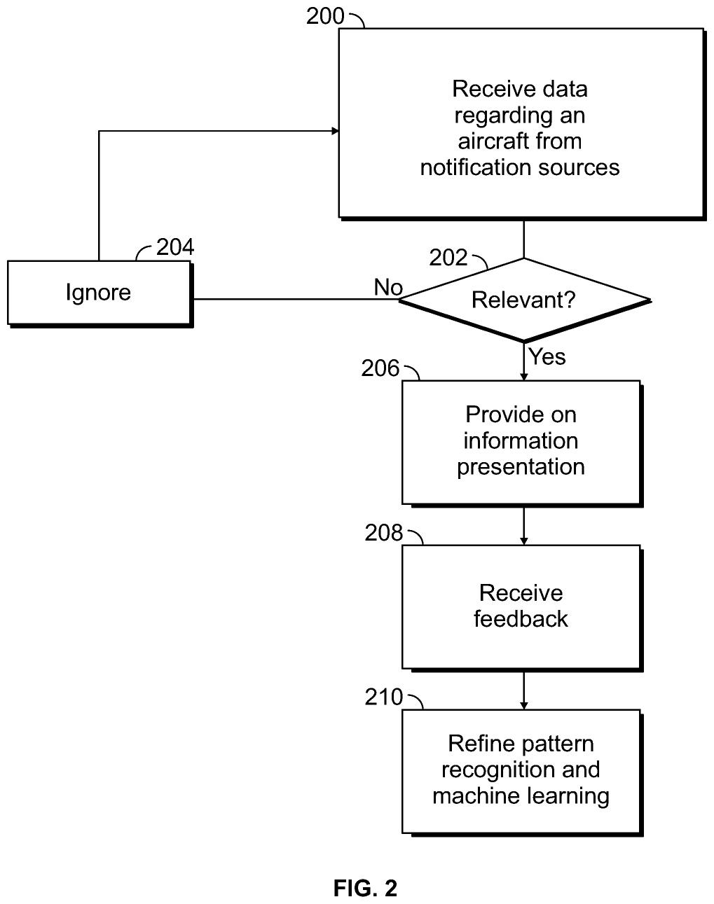

FIG. 2 illustrates a flow diagram of a method, according to an example of the present disclosure. Referring to FIGS. 1 and 2, at 200 the artificial intelligence control unit 102 receives data regarding the aircraft 108 from the notification sources 104. The data includes information regarding the tracked position of the aircraft 108, weather at a location of the aircraft 108, a departure airport for the aircraft 108, and an arrival airport for the aircraft 108, a flight schedule for the aircraft 108, aviation notices for the aircraft 108, airport information, and the like.

At 202, the artificial intelligence control unit 102 determines which information within the data is relevant. For example, the artificial intelligence control unit 102 performs pattern recognition, large language model processing, and/or the like to assess whether information is relevant (such as in relation to a relevancy threshold). If the information is not relevant, the method proceeds to 204, at which the artificial intelligence control unit 102 ignores and/or otherwise discards the information, and the method returns to 200. The artificial intelligence control unit 102 automatically, without human intervention, determines whether or not the information is relevant.

If, however, the artificial intelligence control unit 102 determines that the information within the data is relevant at 202, the method proceeds to 206, at which the artificial intelligence control unit 102 provides such information on an information presentation shown on the display 116 of the aircraft 108. At 208, the artificial intelligence control unit 102 can then receive feedback from the pilot, and, at 210, refine pattern recognition and machine learning based on the feedback.

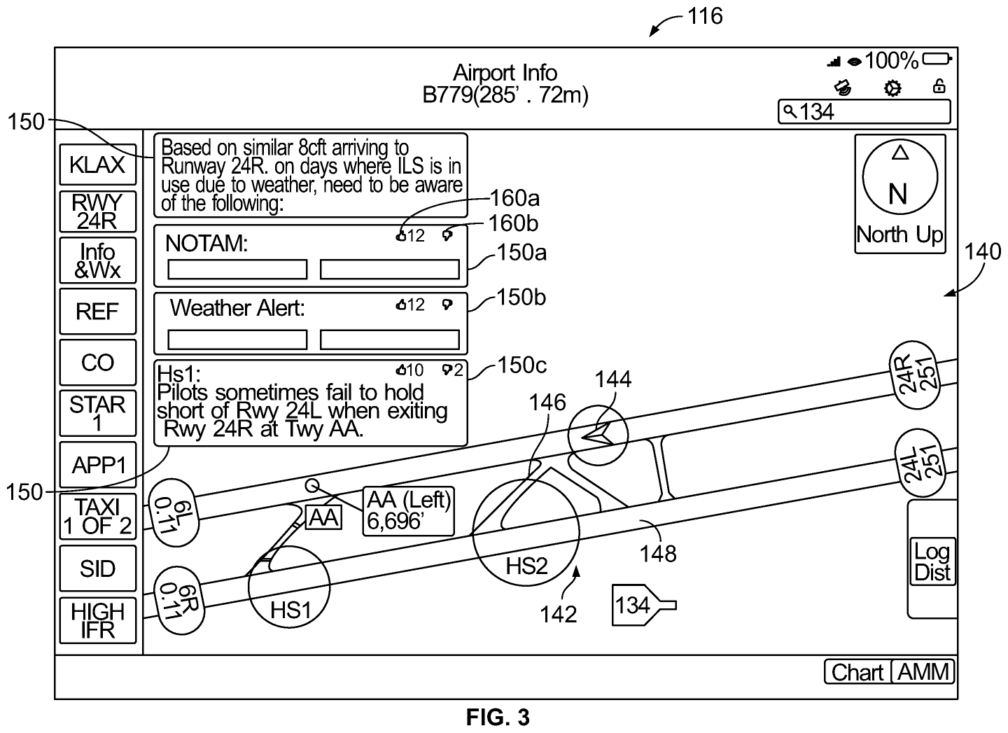

FIG. 3 illustrates a front view of a display 116, according to an example of the present disclosure. Referring to FIGS. 1-3, the artificial intelligence control unit 102 generates and shows the information presentation 140 on the display 116. The information presentation 140 includes a map 142 of an airport where the aircraft 108 currently is located. An indicia 144 of the aircraft 108 is shown on the map 142. The map 142 includes taxiways 146 and runways 148, for example.

The information presentation 140 also includes information prompts 150, which can be overlayed onto the map 142. Examples of the information prompts 150 include information determined from previous aircraft operations on days having similar air traffic, weather, and the like. For example, based on similar types of aircraft arriving at a particular runway on days in which instrument landing system (ILS) is in use due to weather, the artificial intelligence control unit 102 provides an information prompt 150a regarding a NOTAM determined to be relevant, an information prompt 150b regarding a weather alert determined to be relevant, and an information prompt 150c regarding a holding status at a particular location of a runway. As described, the artificial intelligence control unit 102 determines the relevant information from the received data, and presents the relevant information on the information presentation 140, such as via the information prompts 150 in relation to the map 142.

In at least one example, the artificial intelligence control unit 102 also provides feedback input indicators 160a and 160b, such as on each information prompt 150. As an example, the feedback input indicator 160a can be a thumbs up, and the feedback input indicator 160b can be a thumbs down. The pilot can select an appropriate feedback input indicator 160a or 160b based on whether or not a particular information prompt 150 is helpful or not. The artificial intelligence control unit 102 receives feedback through selection of a particular feedback indicator 160a or 160b to further refine the large language model in order to further refine selection of relevant information in the future.

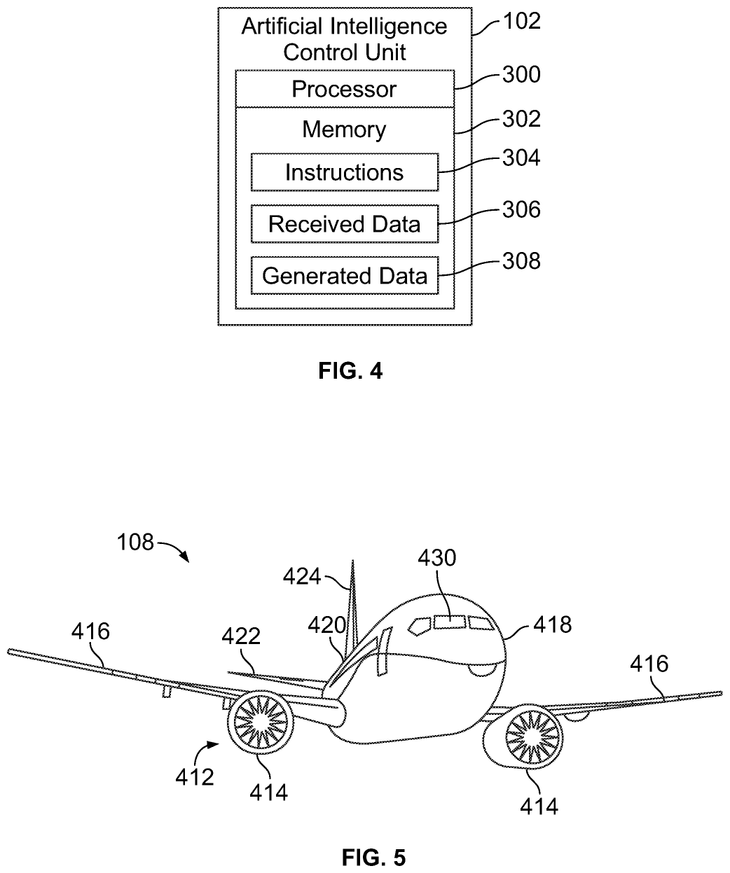

FIG. 4 illustrates a schematic block diagram of the artificial intelligence control unit 102, according to an example of the present disclosure. In at least one example, the artificial intelligence control unit 102 includes at least one processor 300 in communication with a memory 302. The memory 302 stores instructions 304, received data 306, and generated data 308. The artificial intelligence control unit 102 shown in FIG. 4 is merely exemplary, and non-limiting.

As used herein, the term “control unit,” “central processing unit,” “CPU,” “computer,” or the like may include any processor-based or microprocessor-based system including systems using microcontrollers, reduced instruction set computers (RISC), application specific integrated circuits (ASICs), logic circuits, and any other circuit or processor including hardware, software, or a combination thereof capable of executing the functions described herein. Such are exemplary only, and are thus not intended to limit in any way the definition and/or meaning of such terms. For example, the artificial intelligence control unit 102 may be or include one or more processors that are configured to control operation, as described herein.

The artificial intelligence control unit 102 is configured to execute a set of instructions that are stored in one or more data storage units or elements (such as one or more memories), in order to process data. For example, the artificial intelligence control unit 102 may include or be coupled to one or more memories. The data storage units may also store data or other information as desired or needed. The data storage units may be in the form of an information source or a physical memory element within a processing machine.

The set of instructions may include various commands that instruct the artificial intelligence control unit 102 as a processing machine to perform specific operations such as the methods and processes of the various examples of the subject matter described herein. The set of instructions may be in the form of a software program. The software may be in various forms such as system software or application software. Further, the software may be in the form of a collection of separate programs, a program subset within a larger program, or a portion of a program. The software may also include modular programming in the form of object-oriented programming. The processing of input data by the processing machine may be in response to user commands, or in response to results of previous processing, or in response to a request made by another processing machine.

The diagrams of examples herein may illustrate one or more control or processing units, such as the artificial intelligence control unit 102. It is to be understood that the processing or control units may represent circuits, circuitry, or portions thereof that may be implemented as hardware with associated instructions (e.g., software stored on a tangible and non-transitory computer readable storage medium, such as a computer hard drive, ROM, RAM, or the like) that perform the operations described herein. The hardware may include state machine circuitry hardwired to perform the functions described herein. Optionally, the hardware may include electronic circuits that include and/or are connected to one or more logic-based devices, such as microprocessors, processors, controllers, or the like. Optionally, the artificial intelligence control unit 102 may represent processing circuitry such as one or more of a field programmable gate array (FPGA), application specific integrated circuit (ASIC), microprocessor(s), and/or the like. The circuits in various examples may be configured to execute one or more algorithms to perform functions described herein. The one or more algorithms may include aspects of examples disclosed herein, whether or not expressly identified in a flowchart or a method.

As used herein, the terms “software” and “firmware” are interchangeable, and include any computer program stored in a data storage unit (for example, one or more memories) for execution by a computer, including RAM memory, ROM memory, EPROM memory, EEPROM memory, and non-volatile RAM (NVRAM) memory. The above data storage unit types are exemplary only, and are thus not limiting as to the types of memory usable for storage of a computer program.

Referring to FIGS. 1-4, examples of the subject disclosure provide systems and methods that allow large amounts of data to be quickly and efficiently analyzed by a computing device. For example, the artificial intelligence control unit 102 can analyze data from numerous notification services 104, whether or not shown in the Figures. As such, large amounts of data, which may not be readily discernable by human beings, are being tracked and analyzed. The vast amounts of data are efficiently organized and/or analyzed by the artificial intelligence control unit 102, as described herein. The artificial intelligence control unit 102 analyzes the data in a relatively short time in order to quickly and efficiently determine relevant information for a pilot to consider during operation of the aircraft 108. As such, examples of the present disclosure provide increased and efficient functionality, and vastly superior performance in relation to a human being analyzing the vast amounts of data.

In at least one example, components of the system 100, such as the artificial intelligence control unit 102, provide and/or enable a computer system to operate as a special computer system for determining and presenting relevant information to a pilot. The artificial intelligence control unit 102 improves upon standard computing devices by determining such information and automatically communicating with pilots in an efficient and effective manner. In at least one example, the artificial intelligence control unit 102 can analyze operator-specific data including unique frequencies, escape procedures, and/or the like.

In at least one example, all or part of the systems and methods described herein are or otherwise include an artificial intelligence (AI) or machine-learning system that can automatically perform the operations of the methods also described herein. For example, the artificial intelligence control unit 102 is an artificial intelligence or machine learning system. These types of systems may be trained from outside information and/or self-trained to repeatedly improve the accuracy with how data is analyzed to determine and present the relevant information to the pilot. Over time, these systems can improve by determining and communicating with increasing accuracy and speed, thereby significantly reducing the likelihood of any potential errors. For example, the AI or machine-learning systems can learn and determine models, associate such models with received data, and determine potential conflicts. The AI or machine-learning systems described herein may include technologies enabled by adaptive predictive power and that exhibit at least some degree of autonomous learning to automate and/or enhance pattern detection (for example, recognizing irregularities or regularities in data), customization (for example, generating or modifying rules to optimize record matching), and/or the like. The systems may be trained and re-trained using feedback from one or more prior analyses of the data, ensemble data, and/or other such data. Based on this feedback, the systems may be trained by adjusting one or more parameters, weights, rules, criteria, or the like, used in the analysis of the same. This process can be performed using the data and ensemble data instead of training data, and may be repeated many times to repeatedly improve the determinations and communications described herein. The training minimizes conflicts and interference by performing an iterative training algorithm, in which the systems are retrained with an updated set of data, and based on the feedback examined prior to the most recent training of the systems. This provides a robust analysis model that can better determine and present relevant information to a pilot.

FIG. 5 illustrates a perspective front view of an aircraft 108, according to an example of the present disclosure. The aircraft 108 includes a propulsion system 412 that includes engines 414, for example. Optionally, the propulsion system 412 may include more engines 414 than shown. The engines 414 are carried by wings 416 of the aircraft 108. In other examples, the engines 414 may be carried by a fuselage 418 and/or an empennage 420. The empennage 420 may also support horizontal stabilizers 422 and a vertical stabilizer 424. The fuselage 418 of the aircraft 108 defines an internal cabin 430, which includes a flight deck or cockpit, one or more work sections (for example, galleys, personnel carry-on baggage areas, and the like), one or more passenger sections (for example, first class, business class, and coach sections), one or more lavatories, and/or the like. FIG. 5 shows an example of an aircraft 108. It is to be understood that the aircraft 108 can be sized, shaped, and configured differently than shown in FIG. 5.

Further, the disclosure comprises examples according to the following clauses:

Clause 1. A system comprising:
an artificial intelligence control unit configured to:
   receive data from notification sources, wherein the data relate to an aircraft being operated by a pilot,
   determine relevant information for operating the aircraft from the data, and
   provide an information presentation including the relevant information on a display of a user interface of the aircraft,
wherein the aircraft is operated based on the relevant information.

Clause 2. The system of Clause 1, wherein the artificial intelligence control unit is remote from the aircraft.

Clause 3. The system of Clause 1, wherein the artificial intelligence control unit is onboard the aircraft.

Clause 4. The system of any of Clauses 1-3, wherein the notification sources comprise one or more of:
a tracking sub-system configured to track the aircraft;
a weather sub-system;
aviation data sources that provide information regarding aviation flight operations;
aircraft data sources that provide information about the aircraft; or airport data sources that provide information regarding one or more airports.

Clause 5. The system of any of Clauses 1-3, wherein the notification sources comprise:
a tracking sub-system configured to track the aircraft;
a weather sub-system;
aviation data sources that provide information regarding aviation flight operations;
aircraft data sources that provide information about the aircraft; and
airport data sources that provide information regarding one or more airports.

Clause 6. The system of any of Clauses 1-5, wherein the information presentation comprises a map of a current location of the aircraft.

Clause 7. The system of any of Clauses 1-6, wherein the information presentation comprises information prompts that show the relevant information on the display.

Clause 8. The system of Clause 7, wherein the information prompts comprise one or more feedback input indicators that allow the pilot to provide feedback to the artificial intelligence control unit.

Clause 9. The system of any of Clauses 1-5, wherein the information presentation comprises:
a map of a current location of the aircraft; and
information prompts that show the relevant information on the display, wherein the information prompts comprise one or more feedback input indicators that allow the pilot to provide feedback to the artificial intelligence control unit.

Clause 10. The system of any of Clauses 1-9, wherein the artificial intelligence control unit is further configured to automatically operate the aircraft based on the relevant information.

Clause 11. A method comprising:
receiving, by an artificial intelligence control unit, data from notification sources, wherein the data relate to an aircraft being operated by a pilot;
determining, by the artificial intelligence control unit, relevant information for operating the aircraft from the data; and
providing, by the artificial intelligence control unit, an information presentation including the relevant information on a display of a user interface of the aircraft,
wherein the aircraft is operated based on the relevant information.

Clause 12. The method of Clause 11, wherein the artificial intelligence control unit is remote from the aircraft.

Clause 13. The method of Clause 11, wherein the artificial intelligence control unit is onboard the aircraft.

Clause 14. The method of any of Clauses 11-13, wherein the notification sources comprise:
a tracking sub-system configured to track the aircraft;
a weather sub-system;
aviation data sources that provide information regarding aviation flight operations;
aircraft data sources that provide information about the aircraft; and
airport data sources that provide information regarding one or more airports.

Clause 15. The method of any of Clauses 11-14, wherein the information presentation comprises a map of a current location of the aircraft.

Clause 16. The method of any of Clauses 11-15, wherein the information presentation comprises information prompts that show the relevant information on the display.

Clause 17. The method of Clause 16, wherein the information prompts comprise one or more feedback input indicators that allow the pilot to provide feedback to the artificial intelligence control unit.

Clause 18. The method of any of Clauses 11-14, wherein the information presentation comprises:
a map of a current location of the aircraft; and
information prompts that show the relevant information on the display, wherein the information prompts comprise one or more feedback input indicators that allow the pilot to provide feedback to the artificial intelligence control unit.

Clause 19. The method of any of Clauses 11-18, further comprising automatically operating, by the artificial intelligence control unit, the aircraft based on the relevant information.

Clause 20. A non-transitory computer-readable storage medium comprising executable instructions that, in response to execution, cause one or more control units comprising a processor, to perform operations comprising:
receiving data from notification sources, wherein the data relate to an aircraft being operated by a pilot;
determining relevant information for operating the aircraft from the data; and
providing an information presentation including the relevant information on a display of a user interface of the aircraft,
wherein the aircraft is operated based on the relevant information.

As described herein, examples of the present disclosure provide systems and methods for automatically determining relevant information regarding operation of an aircraft. Further, examples of the present disclosure provide systems and methods for presenting the relevant information to a pilot of the aircraft.

While various spatial and directional terms, such as top, bottom, lower, mid, lateral, horizontal, vertical, front and the like can be used to describe examples of the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described examples (and/or aspects thereof) can be used in combination with each other. In addition, many modifications can be made to adapt a particular situation or material to the teachings of the various examples of the disclosure without departing from their scope. While the dimensions and types of materials described herein are intended to define the aspects of the various examples of the disclosure, the examples are by no means limiting and are exemplary examples. Many other examples will be apparent to those of skill in the art upon reviewing the above description. The scope of the various examples of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various examples of the disclosure, including the best mode, and also to enable any person skilled in the art to practice the various examples of the disclosure, including making and using any devices or systems and performing any incorporated methods. The patentable scope of the various examples of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A system comprising:
an artificial intelligence control unit configured to:
receive data from notification sources, wherein the data relate to an aircraft being operated by a pilot,
determine relevant information for operating the aircraft from the data, and
provide an information presentation including the relevant information on a display of a user interface of the aircraft,
wherein the aircraft is operated based on the relevant information.

2. The system of claim 1, wherein the artificial intelligence control unit is remote from the aircraft.

3. The system of claim 1, wherein the artificial intelligence control unit is onboard the aircraft.

4. The system of claim 1, wherein the notification sources comprise one or more of:
a tracking sub-system configured to track the aircraft;
a weather sub-system;
aviation data sources that provide information regarding aviation flight operations;
aircraft data sources that provide information about the aircraft; or
airport data sources that provide information regarding one or more airports.

5. The system of claim 1, wherein the notification sources comprise:
a tracking sub-system configured to track the aircraft;
a weather sub-system;
aviation data sources that provide information regarding aviation flight operations;
aircraft data sources that provide information about the aircraft; and
airport data sources that provide information regarding one or more airports.

6. The system of claim 1, wherein the information presentation comprises a map of a current location of the aircraft.

7. The system of claim 1, wherein the information presentation comprises information prompts that show the relevant information on the display.

8. The system of claim 7, wherein the information prompts comprise one or more feedback input indicators that allow the pilot to provide feedback to the artificial intelligence control unit.

9. The system of claim 1, wherein the information presentation comprises:
a map of a current location of the aircraft; and
information prompts that show the relevant information on the display, wherein the information prompts comprise one or more feedback input indicators that allow the pilot to provide feedback to the artificial intelligence control unit.

10. The system of claim 1, wherein the artificial intelligence control unit is further configured to automatically operate the aircraft based on the relevant information.

11. A method comprising:
receiving, by an artificial intelligence control unit, data from notification sources, wherein the data relate to an aircraft being operated by a pilot;
determining, by the artificial intelligence control unit, relevant information for operating the aircraft from the data; and
providing, by the artificial intelligence control unit, an information presentation including the relevant information on a display of a user interface of the aircraft,
wherein the aircraft is operated based on the relevant information.

12. The method of claim 11, wherein the artificial intelligence control unit is remote from the aircraft.

13. The method of claim 11, wherein the artificial intelligence control unit is onboard the aircraft.

14. The method of claim 11, wherein the notification sources comprise:
a tracking sub-system configured to track the aircraft;
a weather sub-system;
aviation data sources that provide information regarding aviation flight operations;
aircraft data sources that provide information about the aircraft; and
airport data sources that provide information regarding one or more airports.

15. The method of claim 11, wherein the information presentation comprises a map of a current location of the aircraft.

16. The method of claim 11, wherein the information presentation comprises information prompts that show the relevant information on the display.

17. The method of claim 16, wherein the information prompts comprise one or more feedback input indicators that allow the pilot to provide feedback to the artificial intelligence control unit.

18. The method of claim 11, wherein the information presentation comprises:
a map of a current location of the aircraft; and
information prompts that show the relevant information on the display, wherein the information prompts comprise one or more feedback input indicators that allow the pilot to provide feedback to the artificial intelligence control unit.

19. The method of claim 11, further comprising automatically operating, by the artificial intelligence control unit, the aircraft based on the relevant information.

20. A non-transitory computer-readable storage medium comprising executable instructions that, in response to execution, cause one or more control units comprising a processor, to perform operations comprising:
receiving data from notification sources, wherein the data relate to an aircraft being operated by a pilot;
determining relevant information for operating the aircraft from the data; and
providing an information presentation including the relevant information on a display of a user interface of the aircraft,
wherein the aircraft is operated based on the relevant information.
